(19) United States
(12) Patent Application Publication
(10) Pub. No.: US 2010/0115139 A1
(43) Pub. Date: May 6, 2010

(54) COMPUTER NETWORK ARCHITECTURE AND METHOD OF PROVIDING DISPLAY DATA

(75) Inventors: James Quentin Stafford-Fraser, Cambridge (GB); Timothy Holroyd Glauert, Cambridgeshire (GB); Andrew John Fisher, Cambridge (GB); Martin Towle King, Vashon, WA (US)

Correspondence Address: Workman Nydegger;1000 Eagle Gate Tower, 60 East South Temple, Salt Lake City, UT, 84111, US

(73) Assignee: Displaylink (UK) Limited, Cambridge (GB)

(21) Appl. No.: 12/634,578

(22) Filed: Dec. 9, 2009

Related U.S. Application Data
(63) Continuation of application No. 11/005,736, filed on Dec. 7, 2004.
(60) Provisional application No. 60/548,487, filed on Feb. 27, 2004.

(51) Int. Cl. G06F 15/16

(52) U.S. Cl. 709/250

(57) ABSTRACT

Systems and methods are provided having a plurality of ultra-thin client devices coupled to at least one display device and a data processing device coupled to the ultra-thin client devices over a general purpose data network, the data processing device being operable to transmit image data directly representing at least a portion of the image displayed on one or more of the display devices over the general purpose data network.

### CROSS-REFERENCE TO RELATED APPLICATIONS

This application claims the benefit and priority to U.S. patent application Ser. No. 11/005,736, filed Dec. 7, 2004, which application claims priority to U.S. Provisional Patent App. No. 60/548,487, filed Feb. 27, 2004, both of which applications are incorporated by reference herein in their entireties.

### BACKGROUND OF THE INVENTION

1. The Field of the Invention

The present invention relates to computer network architectures and the provision of display data to display devices.

2. The Relevant Technology

The personal computer, as most people think of it today, consists of a display, a processing unit and some input and output devices, typically a keyboard and a mouse. In some embodiments, these units are combined into a single device, a laptop being the most obvious example. However, the majority of computers sitting in offices today consist of one box under the desk, one display on top of the desk, one keyboard and one mouse, all of which are operated by one user. This model has been with us for over two decades.

This dedicated one to one mapping of processing unit and display was brought about by a combination of the physical nature of displays and the methods used to connect the components together. Cathode Ray Tube (CRT) based displays are large heavy and fragile, and so users seldom want more than one on their desk. When more display space is needed it is easier to buy a larger or higher resolution monitor than to provide an entirely new computer or to put a new graphics card into the computer to allow it to connect to more than one monitor. The electrical requirements of the Video Graphics Array (VGA) cable used to connect the processing device to the display make it bulky and limit its length to a few feet so the monitors need to be in close proximity to the machines driving them. Typically each computer has only one VGA connection and it is therefore difficult to connect more than one monitor to a computer. Similarly, it is not easy to share monitors between more than one computer because monitors generally have just one or two inputs. A monitor has historically been closely tied to its display and this one to one mapping has become the norm.

### BRIEF SUMMARY OF THE INVENTION

According to a first aspect of the present invention there is provided a display system comprising: a plurality of ultra-thin client devices, each of which is coupled to at least one display device; and a data processing device coupled to the ultra-thin client devices over a general purpose data network, the data processing device being operable to transmit image data directly representing at least a portion of the image displayed on one or more of the display devices over the general purpose data network.

Preferably, the data processing device includes means to convert graphical data from one or more applications running on the data processing device into the image data directly representing the image for display on the one or more display devices.

It is preferred that the data processing device includes a network interface and that image data output by the network interface is in a bitmap-based format.

The present invention thus dispenses with the limitations imposed by VGA cables. A display device in this system can be placed at great distances from the data processing device, either directly because of the electrical characteristics of the network or by virtue of routers/repeaters. The network may also be wireless. The display device is not tied to the processing device by a short length of cable. The preferred general purpose data network is an ethernet operating at 100 Mb/s, but other networks are also suitable, such as 10 Mb/s and 1 Gb/s ethernet or Universal Serial Bus (USB), IEEE-1394 (Firewire), Asynchronous Transfer Mode (ATM), Bluetooth, Infrared Data Association (IrDA), 802.11 based and Ultra Wide Band (UWB) wireless networks.

As mentioned above, CRT displays are cumbersome. However, the physical nature of displays is now changing. LCD monitors and plasma screens are becoming increasingly prevalent. Consequently, displays are becoming thinner, cheaper and more robust. It has even become possible to hang displays on walls, embed them in furniture, and have several on one desk. It is therefore much more practical to have more than one display at a work station. The present invention allows many displays to be driven from a single computer. Furthermore, communications capabilities are now such that even a small device, such as a PDA, is capable of driving a large display.

Distinct benefits stem from the use of ultra-thin client devices in the display system. Ultra-thin client devices (whether integral in a display device or external in a separate network terminal module), when compared with their heavier-weight predecessors, are typically provided with only a small amount of custom-written firmware, and have no need for a complete operating system or substantial local code. This is generally because the hardware has been assembled with ultra-thin implementations in mind and because much functionality has been moved elsewhere.

On a network, such devices typically communicate using lower-level protocols than their ‘fatter’ predecessors. An ethernet-connected, ultra-thin device might use raw ethernet packets or UDP, for example, instead of protocol suites such as TCP/IP that have greater complexity. The processing unit in ultra-thin client devices can therefore be implemented as custom logic, having a small microcontroller, an FPGA or a simple ASIC. The cost and complexity of a general-purpose CPU chip is thus unnecessary. Furthermore, none of the supporting hardware, software and firmware that often accompany general-purpose CPUs are necessary either.

Another benefit from the use of ultra-thin client devices is the removal of any requirement for local handling of an attached keyboard or mouse (other than to pass events on to the network). Thus the ultra-thin client device does not need a local configuration or setup screen with which the user must interact, and it need not know the layouts of all different international keyboards, which may be plugged into it. Sophisticated configuration screens may be presented to the user, but they originate elsewhere on the network. This makes it easier for them to be tailored for particular applications or installations than if they were hard-coded into the device.

Conveniently, all configuration of ultra-thin client devices can be done over the network, simplifying deployment and management. This makes it easy, for example, to duplicate a particular configuration to large numbers of such devices, or for user-specific preferences such as audio volume controls or keyboard repeat rates to follow the user around the network. In doing so, the device needs to store little or no local configuration data.

Since all applications are typically stored and run at the server, rather than on the ultra-thin client device, the device needs no user-reprogrammable persistent storage (hard disks etc).

Ultra-thin client devices are stateless, which means that the device can be rebooted, or easily replaced in case of failure, with no loss to data and minimum reconfiguration. They can be implemented as pure solid-state devices. They need no moving parts, making them more robust, especially in hostile environments. They are furthermore often completely silent in operation.

The simplicity of ultra thin client devices means that a connected network server can be given a more complete understanding of its internal workings and can use this to optimise the end-to-end system.

At least one of the ultra-thin client devices is preferably a network enabled display (NED), the NED having a display device and ultra-thin client componentry, the ultra-thin client componentry being coupled internally to the display device.

Alternatively or additionally, at least one of the ultra-thin client devices is a separate module having ultra-thin client componentry, the ultra-thin client componentry being coupled externally to the or each display device.

It is preferred that the data processing device is arranged to execute software in kernel-mode and user-mode, at least a portion of the kernel-mode software being a graphics card driver emulator for receiving graphical data from a user-mode application.

A portion of the software executing on the data processing device may be a user-mode helper application, where the user-mode helper application generates image data and transmits the image data to the network in a format suitable for delivery directly across the general purpose data network.

Preferably, the user-mode helper application includes a user interface to allow a user to configure the system. Alternatively, a further user-mode application may be provided that includes a user interface to allow a user to configure the system.

Advantageously, the data processing device may maintain a framebuffer and present data held in the framebuffer to the graphics card driver emulator to facilitate the representation of data for display on at least one of the display devices.

The data processing device preferably maintains a plurality of framebuffers, each of the framebuffers corresponding to the image data for presentation for a respective display device.

The kernel-mode graphics card driver emulator may simulate a plurality of graphics cards.

For convenience, the image data output by the network interface may be in compressed form. As a result, the bandwidth used for sending image data may be reduced. Preferably, the compressed image data is compressed in accordance with a lossless compression algorithm.

In a further alternative, the data processing device preferably includes an encryption engine and the image data output by the network interface is encrypted by the encryption engine.

Where there is a user-mode helper application executing on the data processing device, each ultra-thin client device is advantageously assigned a unique network address and the user-mode helper application includes means for adding network address information to the image data, thereby allowing image data to be routed to a particular display device.

In a preferred embodiment, each of the ultra-thin client devices also includes a local framebuffer for storing the image data locally and a decoder unit for transferring data from the network to the local framebuffer, whereby only changes to images need to be sent to the ultra-thin client devices.

In another preferred embodiment, the display system further includes a main display device coupled directly to the data processing device, thereby allowing at least one of the display devices coupled to the data processing device over the network via an ultra-thin client device to be an auxiliary display device.

In accordance with another aspect of the present invention, there is provided a display adaptor comprising: a network interface for receiving image data from a general purpose data network; a display interface for connection to one or more display devices; and drive circuitry for driving image data received from the network interface such that a display device connected to the display interface is suitable for use in a display system of the first aspect of the present invention.

Preferably, the display adaptor further includes a framebuffer for storing image data, and one or more decoder units for transferring data from the network interface to the framebuffer, wherein the drive circuitry drives image data from the framebuffer.

Conveniently, the display adaptor may be integral in at least one of the display devices.

The display adaptor is thus an ultra-thin client device that permits conventional display devices to be adapted for use as network enabled displays.

In some implementations, other peripherals may be coupled to ultra-thin client devices. Drivers for these peripherals do not in general need to reside on the device. Instead the device sends the raw data over the network to other machines which have the ability to handle larger libraries of device drivers.

In accordance with yet another aspect of the present invention, there is provided a method for generating display data for presentation on a plurality of display devices over a general purpose data network, the method comprising: generating graphical data for display on a display device; and converting the graphical data into an image data format suitable for transmission over the general purpose data network, wherein the conversion of the graphical data includes: passing the graphical data to a kernel-mode graphics card driver emulator module, which maintains a framebuffer for at least one of the display devices; and passing data from the framebuffer to a user-mode helper application, which formats the image data in a the framebuffer into a format suitable for delivery directly across the general purpose data network.

The image data is not processed by an operating system at the display end of the network. Consequently, the processing power requirement for the display devices is kept low while allowing images to be displayed at high speed. The size and cost of display devices in the display system of the present invention is therefore not limited by the need for high power CPUs. A display device may run an operating system for some other reason, for example to provide a web based format, but the image data transmitted over the network is not processed by a conventional operating system in order to drive a display.

Furthermore, as the image data directly represents an image to be displayed on the display device, the data, in uncompressed form, directly represents pixel values in a matrix of pixels. The data does not require conversion from some more abstract format such as Hypertext Markup Language (HTML), eXtensible Markup Language (XML), Wireless Access Protocol (WAP), X11, Remote Display Protocol (RDP), Independent Computing Architecture (ICA) etc. nor is it an analog data signal such as VGA data. The image data may be compressed or encoded using run length encoding or some other form of lossless encoding but remains intrinsically a direct representation of an image for display.

It is possible for the display system to comprise a plurality of data processing devices, each coupled to the general purpose data network.

The architecture of present invention provides greater flexibility between processing devices and displays than any prior architectures. Displays can be shared and more than one display can be used by a single processing machine at any one time. General purpose data networks are normally packet or circuit based thereby allowing multiple monitors to be driven on a single connection. The displays can be individually addressed as described above, updated by broadcasting the same data to several of them or grouped so that an array of monitors appears to be a single larger display.

Similarly, displays need no longer be dedicated to a single machine. They can be used by different processing devices in succession, an example being a projector at a conference which is driven in turn by a laptop computer belonging to each speaker. Alternatively, they can be updated by several machines at once. A display screen may be partitioned by screen area or overlaid or partitioned in some other way such that different parts or aspects of it are controlled from different places. An example might be a display showing a presentation sent to it from one processing device, with subtitles in another language being sent from a different processing device. In general, however, it is envisaged that just one data processing device will drive a display at any one time.

It is preferred that each ultra-thin client device in the system of the present invention includes a network interface and circuitry to drive a display from the received data. Preferably, each of the ultra-thin client devices also includes a local framebuffer for storing the image data locally, so that it is only changes to images that need to be sent to the display devices, and a decoder unit or units for transferring data from the network interface to the framebuffer. The network interface, drive circuitry, framebuffer and decoder units may all be embedded within the display device, incorporated in a cable connected to the display, incorporated in a power plug or adapter connected to the display or be packaged in a separate module to which both the network and display are connected (i.e. a network to video converter). Thus, existing displays can simply be made compatible with the system of the present invention.

The display system is capable of coupling one or more user interface devices to the general purpose data network. Examples of user interface devices include a keyboard, a mouse and a pointer. User interface devices may be connected directly to the network or via another network device. Some or all of the display devices may be coupled to the general purpose data network independently of any user interface devices.

Preferably, the general purpose data network is used to transport image data to each ultra-thin client device, and thus ultimately to display devices, but it can also carry other data to and from the ultra-thin client devices, including audio output or keyboard and pointer input information.

Preferably, each display device has greater memory than that required for storing a single framebuffer. The excess memory space can be used, amongst other things for caching and double buffering.

As stated above, the network interface, drive circuitry, framebuffer and decoder may be formed as a separate module connected both to the network and to the display device. Power for this module may come from a separate power supply or be provided by the monitor or supplied over the network. Even in the case where power and other connections are electrically independent they may still be bound together into the same physical cable.

Preferably, the display system further includes a device management service for managing devices (such as displays and peripherals) attached to the network. The device management service may be implemented on a single processing device or distributed on a plurality of processing devices coupled to the network. A dedicated processing device may be provided and exclusively devoted to device management.

Peripheral devices may also be included in the display system. Peripheral devices such as scanners or printers may be connected to the general purpose data network and have a unique network address.

### BRIEF DESCRIPTION OF THE DRAWINGS

Examples of the present invention will now be described in detail with reference to the accompanying drawings, in which:

FIG. 1 is a schematic illustration of the component parts of a data processing device and a display device in accordance with one example of the present invention;

FIG. 2 is a schematic illustration of the relationship between user-mode and kernel-mode software applications within an operating system;

FIG. 3 is a schematic illustration of the preferred system for converting graphical data into network data and transmitting that data in the present invention;

FIG. 4 illustrates a first network topology of the present invention;

FIG. 5 illustrates a second network topology of the present invention; and

FIG. 6 illustrates a third network topology of the present invention.

### DETAILED DESCRIPTION OF THE PREFERRED EMBODIMENTS

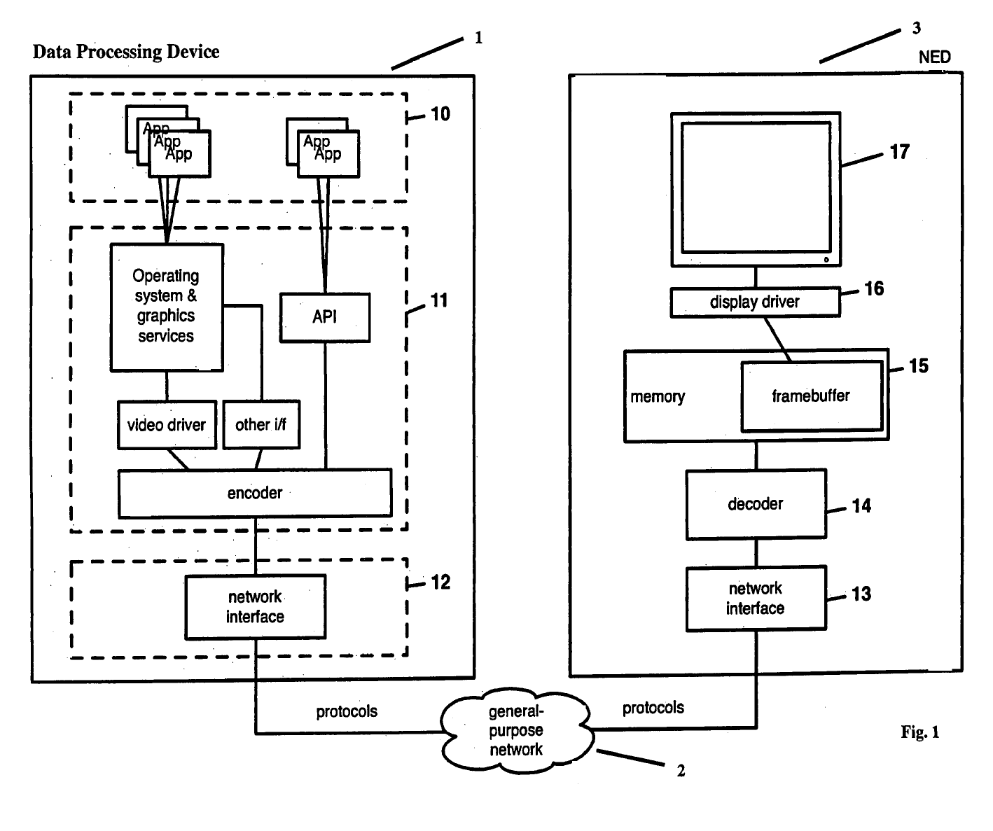

Referring to FIG. 1, a system in accordance with an embodiment of the present invention has a data processing device 1 (such as a personal computer, laptop or PDA) from which image data is transferred and a display device 3 connected to the data processing device 1 over a network 2. A display device 3 of this sort will hereinafter be referred to as a network enabled display (NED 3).

FIG. 1 shows a data processing device 1 running applications 10, software and/or hardware components 11 for converting graphical data and a network interface 12. The NED 3 includes a network interface 13, a decoder 14, a memory 15 and display driver 16, as well as a display screen 17.

A recent trend in the field of electronics devices has been the introduction of a new class of very simple network-connected devices, sometimes referred to as ‘ultra-thin devices’ or ‘ultra-thin clients’. The name comes from a comparison with more traditional networked devices—computers or large peripherals like laser printers—which can be expensive, cumbersome and complex to manage. Ultra-thin devices, on the other hand, are designed for performance, simplicity and low cost. This is made possible by a conscious decision to move functionality, wherever possible, from the device to other entities on the network which already have plentiful processing and storage capabilities.

NEDs include both ultra-thin client componentry and display device components. In an example that illustrates how thin “ultra-thin” can be, a NED might be attached to a very high-speed fibre network which received the raw pixel data to be displayed in scan-line order at a high-enough and consistent-enough rate that it could be rastered directly onto the screen. Such a device would need only very simple (though high-performance) ultra-thin client componentry and, in terms of the well-known 051 layer model, would operate entirely at the Data Link Layer (layer 2) and below. Such devices may become the norm in future when sufficiently high-bandwidth networks are widely deployed. Characteristically, ultra-thin client devices only have a small amount of custom-written firmware. There is no need for a complete operating system or substantial local code, since the vast majority of processing is carried out remotely. In a typical embodiment of ultra-thin client devices, there is a total of about 2 Kbytes of software in the device.

In an alternative embodiment of the present invention (not illustrated), a conventional display device is adapted for use as a NED by the provision of a separate module incorporating ultra-thin client componentry (i.e. a network interface, a decoder, a memory and a display driver). These ultra-thin client components may be incorporated in a cable connected to a display. They may also be incorporated in a power plug or adapter connected to the display. Furthermore, they may be packaged in a separate module to which both the network and display are connected (i.e. an external display adaptor). In each case, conventional display devices can be adapted for use with the general purpose network and thus made compatible with the system of the present invention. The separate module may include ports allowing user interface devices associated with a particular display to connect to the network.

A typical implementation of the present invention in which data is displayed on a NED 3 will now be described with reference to FIG. 1, in terms of the specific steps the data goes through.

First, an application or group of applications 10 on the data processing device 1 creates some graphical output. The application might, for example, draw some text or display an image. The application may have the facilities to render the graphical output into pixels itself, it may make use of some library software which provides graphics services, or it may use a graphics protocol or other description of the desired output. In the following example a single application is described, but it should be noted that the invention is applicable to multiple applications, typically those creating a workspace environment belonging to a particular user of the system.

The graphical output is then converted on the data processing device 1 by one or more software or hardware components 11 into a format suitable for sending over a network connection to a display. In certain preferred embodiments of the present invention, this is done by software.

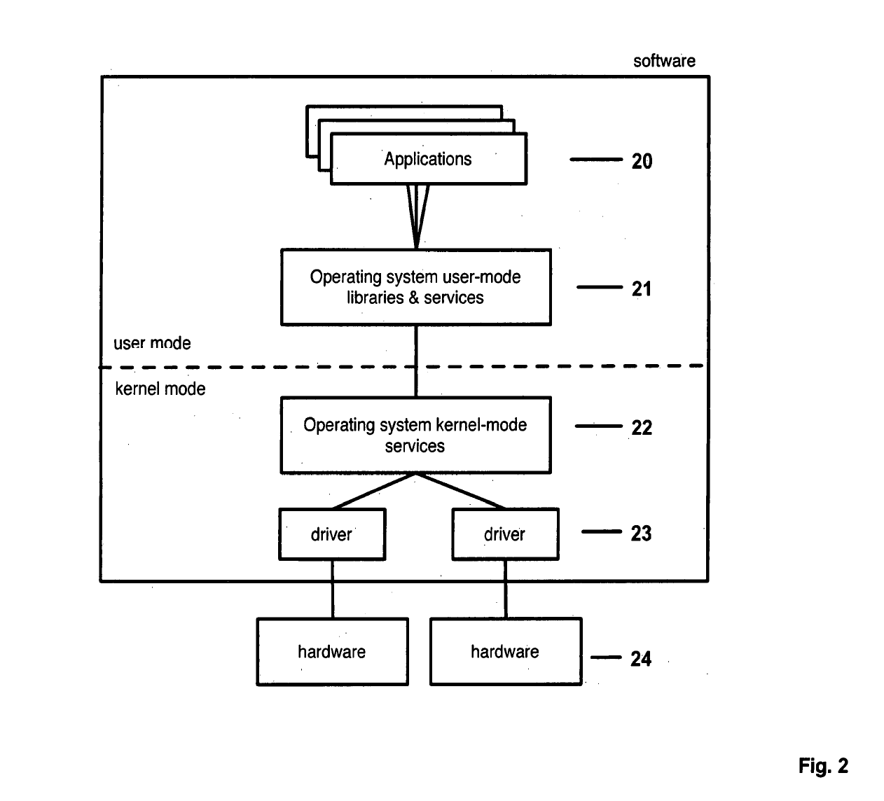

One skilled in the art will recognise that most modem operating systems allow software to run in two modes, referred to herein as kernel-mode and user-mode. User-mode software does not have direct access to the hardware in the system, but must go through the operating system to effect commands. In contrast, kernel-mode software is able to drive hardware directly. A schematic illustration of this is shown in FIG. 2. A typical user-mode application 20, such as a web browser, might need to retrieve information from the network and display it on screen. However, it would not be able to communicate directly with either the network card or the graphics card (examples of hardware 24). Instead, it would use user-mode libraries provided by the operating system 21, which in turn would communicate with kernel-mode services 22. These would interact with the kernel-mode device drivers 23, and these drivers 23 would make contact with the hardware 24. Kernel-mode programs, therefore, may be thought of as working at a lower ‘level’ than the operating system while user-mode programs work at a higher level.

Previous protocols for converting graphical output into network output have intercepted graphical data in the user-mode phase. Examples of these include the X-Windows Protocol, Microsoft's Remote Display Protocol, VNC and the Citrix ICA protocol. As will be described in more detail below, the present invention utilizes a kernel-mode graphics driver emulator.

The kernel-mode driver emulator emulates the behaviour of graphics card driver software without actually driving a graphics card; in particular, it maintains a framebuffer of image data in a format understood by a display device. Clearly, the emulator is not restricted to emulating existing graphics card drivers, it may simulate a driver for more than one graphics card or a graphics card driver for graphics cards with a plurality of outputs and/or with additional memory for framebuffers. The emulator is thus a ‘virtual’ graphics card driver that appears, to the rest of the software executing on the data processing device, to be a “real” graphics card driver. In the simplest case, the graphics card driver emulator emulates a driver for one graphics card with one output. Such an approach is advantageous in the present invention because it is simpler and thus provides improved performance when only low-level information is intended to be transmitted on the network.

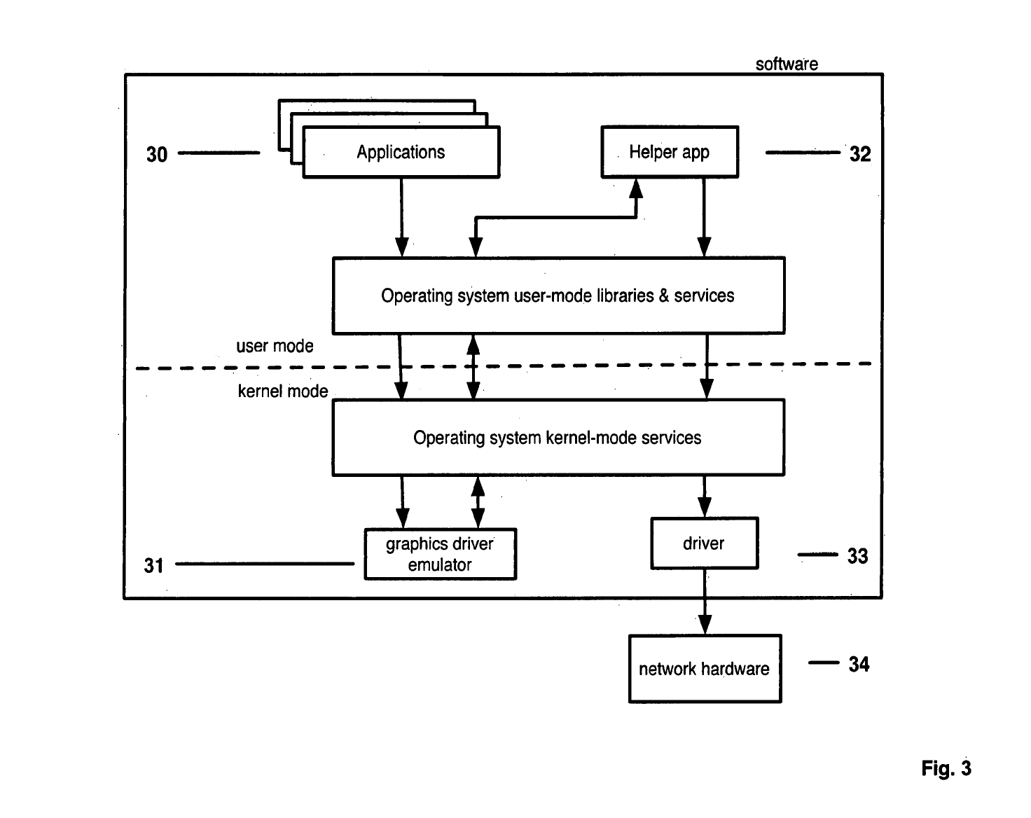

A schematic illustration of a preferred system for converting graphical data into network data and transmitting that data is shown in FIG. 3. Applications 30 produce graphical output, and this is processed as before through the operating system. At this point the instructions are carried to the kernel-mode graphics card driver emulator 31.

Preferably the graphics card driver emulator maintains one or more framebuffers in main memory and updates the remote display or displays when the framebuffer is changed.

For maximum performance the output of the graphics card driver emulator would ideally be directly fed into a driver for a network to be relayed across the system. However, many system architectures do not allow communications between different devices at the kernel level. It is therefore necessary to relay the information to a user-mode helper application 32. This relays the data to the network interface subsystem (33 with 34) which is responsible for putting that data onto the network in such a way that it will reach its intended destination (the NED 3), for example, by putting an address header on each packet of image data. Preferably the helper application provides a user-interface allowing the user of the system to configure the system. It may also provide an interface allowing other applications to configure the system.

Pixel data included in the command stream may be in ‘raw’ form or may be compressed in some way. The data compression/decompression method used will in general be lossless. An encryption engine may be used to encrypt the pixel/command data before it is sent over the network.

Referring again to FIG. 1, the network interface subsystem 13 on each NED 3 receives data intended for that NED 3. Generally this will be specifically addressed to the individual display, although it may also be data which is broadcast or multicast to multiple NEDs 3.

The received data is decoded at decoder 14. This may involve a security/decryption unit. The data intended for display is converted into a form suitable for writing into a framebuffer or cache. The data may also include commands which manipulate the framebuffer, cache or the display in other ways. The COPY command described below is a typical example.

Pixel data is written into the framebuffer directly or into other memory 15 for possible future display or manipulation by later commands. A subsystem 16 is responsible for taking the data in the framebuffer and using it to drive the display. This process is well understood in the art and will depend on the nature of the display used. In the following description of the protocols that may be used, the term ‘length’ refers to a measure of the amount of data being sent, and the term ‘address’ refers to a location in the memory of a NED 3. Either of these may be specified in different ways—an address, for example, may be a conventional byte or word address in memory, or it may be specified in (x,y) coordinates. A length may be a number of bytes, words or pixels. References to the NED's 3 memory may indicate part of the framebuffer or ‘off-screen’ memory.

Commands that may be sent to the NED 3 include but are not limited to:

RAW—Raw Pixel Data

This command is accompanied by an address, a length, and the amount of pixel data specified by the length, which is to be written into the NED's 3 memory at the specified address.

RLE—Run-Length Encoded Pixel Data

This is similar to RAW except that the pixel data is encoded as one or more repetitions of (count, value), each indicating that the specified number of pixels of the given value should be written into memory.

COPY—Copy Pixel Data

This command is accompanied by a source address, a destination address, and a length indicating the amount of data to be copied from the former to the latter.

SYNC—Framebuffer Ready

Most NEDs 3 will have at least two framebuffers, to allow for double-buffering of the display, and this command indicates that a framebuffer has been updated to a consistent ‘complete’ state and is suitable for displaying to the user.

In one embodiment, each command is represented by a particular byte value and is followed by its arguments in the data stream. In a variation on the above commands, any pixel operations may be considered to act on a rectangular area, rather than a purely sequential line of memory. The commands then include an indication of the width of the rectangle and, if an x-coordinate is not already specified, the offset required to continue from one line to the next.

Information sent from the NED 3 back to the data processing device 1 typically includes confirmation of the above commands and status information.

More conventional approaches to this problem would employ several general-purpose protocol layers, resulting in an accumulation of many small delays which reduce the performance.

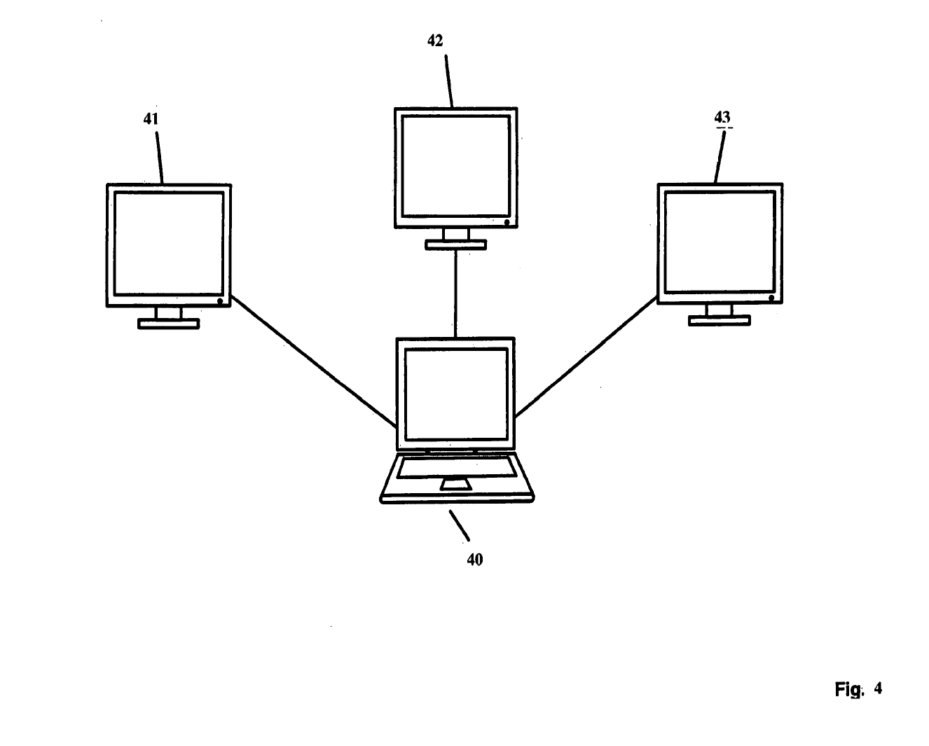

One commercially important use of this technology is to make the process of adding multiple screens to a computer much simpler. FIG. 4 illustrates a first network topology that may implement the present invention. A data processing device is illustrated as a laptop computer. The data processing device 40 has its own conventional display device but is also connected to a number of NEDs 41, 42, 43. As shown each NED 41, 42, 43 has its own dedicated connection to the host. Alternatively, the NEDs 41, 42, 43 can be simply plugged into the same network as the machine, or into another network to which it has access, and an association is made in software between those NEDs 41, 42, 43 and the particular computer.

Software or hardware on the data processing device 40 may make the extra NEDs 41, 42, 43 appear to be part of the same workspace shown on the main screen, typically by emulating a graphics card or driver software in the manner described above, so that programs running on the data processing device 40 are unaware that their output is being displayed on a NED 41, 42, 43. In a typical scenario, windows on a conventional screen can be moved across to the NED 41, 42, 43 simply by dragging them off one side of the main display. A simple user interface would generally be provided to enable users to control which NEDs 41, 42, 43 were part of this extended workspace, the geometric relationship between them and any conventional displays, and other aspects of the system.

In a variation on this theme, the software which drives the NED 41, 42, 43 may also emulate some other device on the data processing device 40, the most obvious example being a printer. Software which knows nothing about NEDs 41, 42, 43 can still display (relatively static) images on them by employing the same methods it would use for printing a page.

The model of a workstation display showing multiple windows and icons on a single display is common and effective for users sitting in front of a screen and interacting with multiple applications or documents on it. It is less appropriate if a display is being devoted entirely to a particular application or if it is not close (or even visible) to the user of the machine. For example, a NED which displays a slide show in a shop window is only visible from the outside of the building. These displays may also be at a greater distance from the data processing device than would be easily possible with conventional display-driving mechanisms. For whatever reason, interacting with the NED as if it were simply part of the main display may not be ideal.

In these cases, software is written or modified to be compatible with NEDs and to drive one or more of them explicitly. A typical use might be the control of multiple displays on a railway platform for informational and/or advertising purposes. The host machine may also have some displays running conventional desktop applications, but this is not necessary, and indeed it may not normally have a ‘user’ at all in the conventional sense. NEDs may also be driven by consumer electronics devices such as central heating controllers, games machines or voicemail systems.

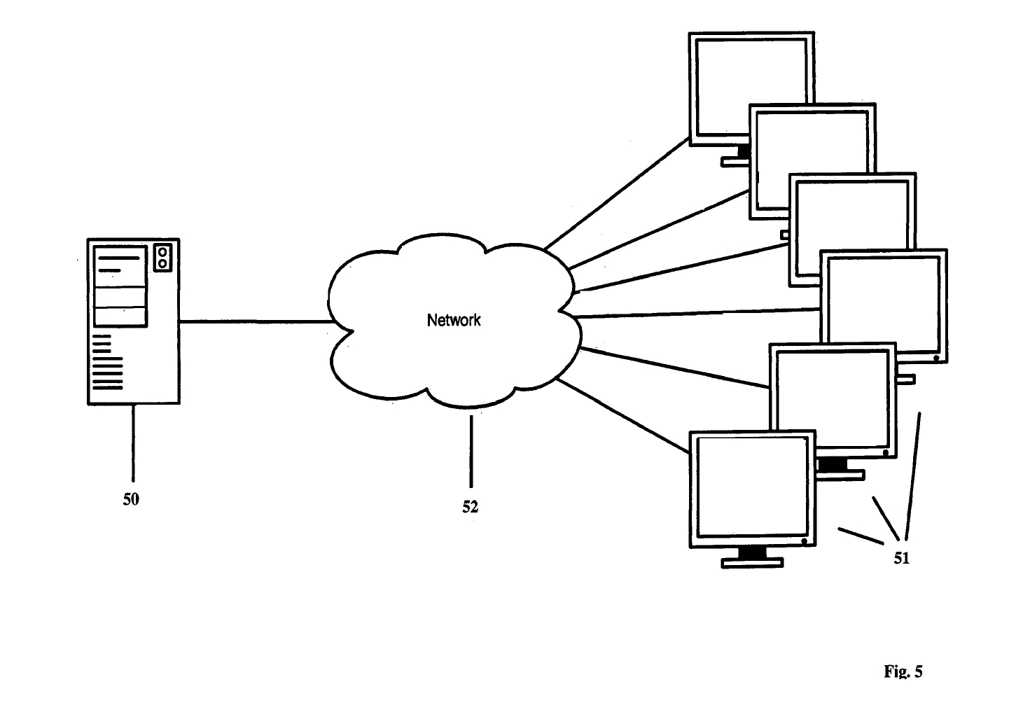

FIG. 5 shows a network topology in which a single data processing device 50 is connected over a general purpose data network 52 to a plurality of NEDs 51. The data processing device 50 does not necessarily have its own display.

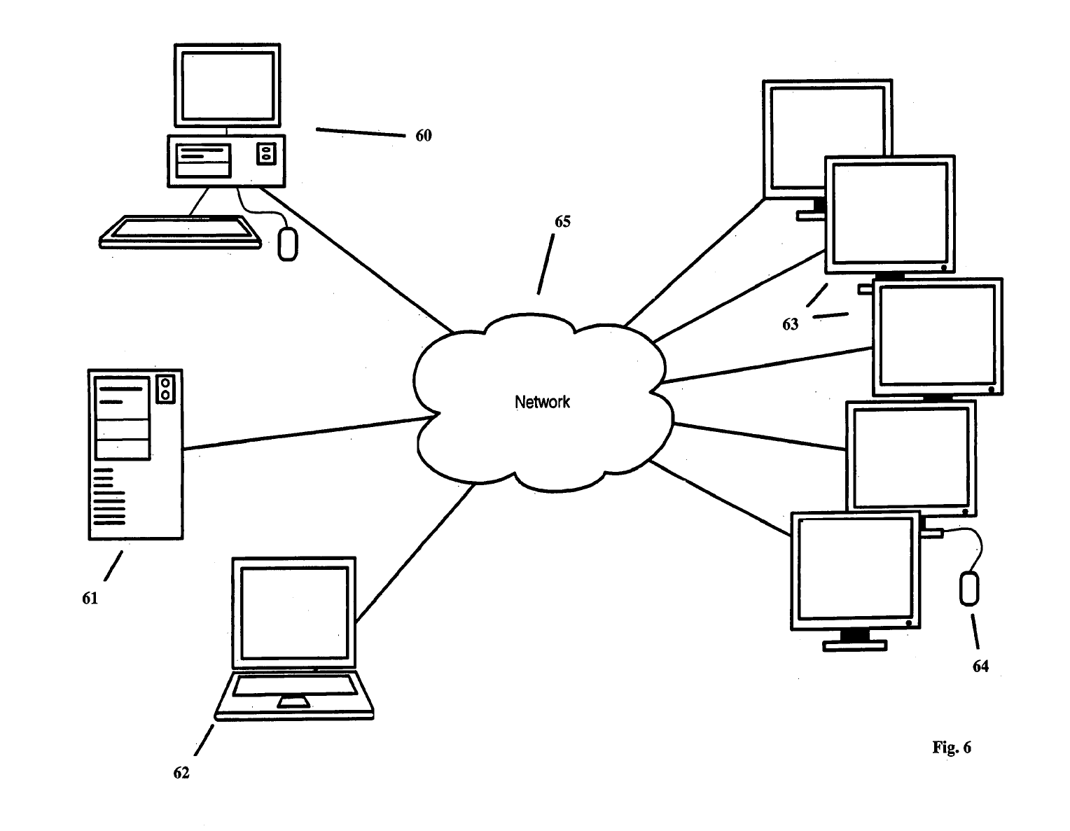

FIG. 6 shows a more complex network arrangement including other network devices such as a PC 60 including keyboard and mouse, a server 61 and a laptop 62 and NEDs 63. A mouse 64 is also shown connected to one of the display devices 63. Any number of devices may be added to the network 65 and may be dedicated to particular tasks such as a display for displaying the time, or a server for providing network management. The NEDs 63 may support a keyboard and pointer, or other input and output devices, whose data is fed back to the driving machine. Each of these added peripherals may have a corresponding network address. Many of these terminals may be connected to one machine (i.e. data processing device). The important distinction between a NED 63 with added peripherals 64 and a conventional workstation is that, as with the graphical output to the screen, minimal support for the peripherals is provided at the NED 63. It is simply a means for connecting them to the network 65, and the details of driving them and interpreting the returned data is delegated to the data processing device.

In any of these applications, a separate device management service may exist on the network or be running on one or more of the machines. Its job is to facilitate, authorise, control and otherwise manage the mapping of machines to ultra-thin client devices, in particular NEDs. This management system, whether separate or integrated in the other parts of the architecture, may have a user interface which allows operators to interact with it directly. Other services on the network might also manage the displays in other ways, for example, switching them to a power-saving standby mode at night, or displaying messages which are independent of the primary driving ‘stream’.

Any but the most basic implementation would need to implement some level of security to stop one machine drawing on a display for which it was not authorised, or two machines attempting to update the same display at once if this was not desirable.

A simple scheme could be as follows. When a NED is first switched on, it is not owned by anybody. The first machine to contact it can claim ownership of it. This contact may be from a device management service running on the network. The NED receives data from that first machine (and only that machine) provided the machine keeps renewing contact with it every so often. If the contact times out, any machine may then claim ownership again. The ‘owning machine’ may pass ownership of a NED to any other machine and in doing so loses ownership itself.

In a typical implementation, the ownership would be characterised by the network address of the owning machine being stored in the NED and traffic from any other machine being ignored. This ‘filtering address’ would be cleared if a timer expired before the address was renewed, after which traffic would be accepted from any host. However, more sophisticated ownership schemes may be used.

The traffic between host and display may also be encrypted to stop third-parties snooping on the network data. Furthermore, a method for reading back the data currently displayed on a NED, or verifying that it matches some known state may be provided.

The requirements for the system at the “host end” can be supplied as software and run on conventional machines. No new hardware is necessarily required at the host.

What is claimed is:

1. A display system comprising:
a plurality of ultra-thin client devices, each of which is coupled to at least one display device; and
a data processing device coupled to the ultra-thin client devices over a general purpose data network, the data processing device being operable to transmit image data directly representing at least a portion of the image displayed on one or more of the display devices over the general purpose data network.

2. A display system as claimed in claim 1, wherein the data processing device includes a network interface and wherein image data output by the network interface is in a bitmap-based format.

3. A display system as claimed in claim 1, wherein at least one of the ultra-thin client devices is a network enabled display (NED), the NED having a display device and ultra-thin client componentry, the ultra-thin client componentry being coupled internally to the display device.

4. A display system as claimed in claim 1, wherein at least one of the ultra-thin client devices is a separate module having ultra-thin client componentry, the ultra-thin client componentry being coupled externally to the or each display device.

5. A display system as claimed in claim 1, wherein the data processing device is arranged to execute software in kernel-mode and user-mode, at least a portion of the kernel-mode software being a graphics card driver emulator for receiving graphical data from a user-mode application.

6. A display system as claimed in claim 5, wherein a portion of the software executing on the data processing device is a user-mode helper application, the user-mode helper application generating image data and transmitting the image data to the network in a format suitable for delivery directly across the general purpose data network.

7. A display system as claimed in claim 6, wherein the user-mode helper application includes a user interface to allow a user to configure the system.

8. A display system as claimed in claim 6, wherein a further user-mode application includes a user interface to allow a user to configure the system.

9. A display system as claimed in claim 5, wherein the data processing device maintains a framebuffer and presents data held in the frame buffer to the graphics card driver emulator to facilitate the representation of data for display on at least one of the display devices.

10. A display system as claimed in claim 9, wherein the data processing device maintains a plurality of framebuffers, each of the framebuffers corresponding to the image data for presentation for a respective display device.

11. A display system as claimed in claim 5, wherein the kernel-mode graphics card driver emulator simulates a driver for a plurality of graphics cards.

12. A display system as claimed in claim 1, wherein the data processing device includes a network interface and wherein image data output by the network interface is in compressed form.

13. A display system as claimed in claim 12, wherein the compressed image data is compressed in accordance with a lossless compression algorithm.

14. A display system as claimed in claim 1, wherein the data processing device includes a network interface and an encryption engine and wherein the image data output by the network interface is encrypted by the encryption engine.

15. A display system as claimed in claim 6, wherein each ultra-thin client device is assigned a unique network address and the user-mode helper application includes means for adding network address information to the image data, thereby allowing image data to be routed to a particular display device.

16. A display system as claimed in claim 1, wherein each of the ultra-thin client devices includes a local framebuffer for storing the image data locally and a decoder unit for transferring data from the network to the local framebuffer, whereby only changes to images need to be sent to the ultra-thin client devices.

17. A display system as claimed in claim 1, further including a main display device coupled directly to the data processing device, thereby allowing at least one of the display devices coupled to the data processing device over the network via an ultra-thin client device to be an auxiliary display device.

18. A display adaptor comprising:
a network interface for receiving image data from a general purpose data network;
a display interface for connection to one or more display devices; and
drive circuitry for driving image data received from the network interface such that a display device connected to the display interface is suitable for use in a display system as claimed in any one of the preceding claims.

19. A display adaptor as claimed in claim 18, wherein the display adaptor further includes a framebuffer for storing image data, and a decoder unit or units for transferring data from the network interface to the framebuffer, wherein the drive circuitry drives image data from the framebuffer.

20. A display adaptor as claimed in claim 18, wherein the adaptor is integral with one of the display devices.

21. A method for generating display data for presentation on a plurality of display devices over a general purpose data network, the method comprising: generating graphical data for display on a display device; and
converting the graphical data into an image data format suitable for transmission over the general purpose data network,
wherein the conversion of the graphical data includes:
passing the graphical data to a kernel-mode graphics card driver emulator module, which maintains a framebuffer for at least one of the display devices; and
passing data from the frame buffer to a user-mode helper application, which formats the image data in a the framebuffer into a format suitable for delivery directly across the general purpose data network.
